(19) United States
(12) Patent Application Publication
(10) Pub. No.: US 2023/0416486 A1
(43) Pub. Date: Dec. 28, 2023

(54) MICROPOROUS ARTICLES AND CORRESPONDING FORMATION METHODS

(71) Applicant: SOLVAY SPECIALTY POLYMERS USA, LLC, Alpharetta, GA (US)

(72) Inventors: Emanuele Di Nicolo', Gorla Minore VA (IT); Dario Aurilia, Cerro Maggiore MI (IT); Jason Rich, Roswell, GA (US); Kelly D. Branham, Woodstock, GA (US)

(73) Assignee: SOLVAY SPECIALTY POLYMERS USA, LLC, Alpharetta, GA (US)

(21) Appl. No.: 18/251,806

(22) PCT Filed: Oct. 28, 2021
(86) PCT No.: PCT/EP2021/080053

§ 371 Date: May 4, 2023

Related U.S. Application Data
(60) Provisional application No. 63/109,648, filed on Nov. 4, 2020.

(51) Int. Cl. C08J 9/00; C08J 9/28; B01D 69/08; B01D 71/52; B01D 69/06; B01D 69/04; B01D 67/00; B01D 71/76

(52) U.S. Cl. CPC C08J 9/0061; C08J 9/28; B01D 69/081; B01D 71/5221; B01D 71/5222; B01D 69/06; B01D 69/043; B01D 67/003; B01D 71/76; C08J 2379/02; C08J 2471/10; C08J 2201/0424; B01D 61/14

(57) ABSTRACT

This invention relates to certain microporous articles comprising certain PEDEK-PEEK copolymers, to a method for making said microporous articles, in particular to a method of making microporous articles from a blend comprising said PEDEK-PEEK copolymer and at least one additional polymer, comprising processing said blend into a film and treating the film with a solvent for obtaining the microporous article.

This application claims priority to U.S. Provisional Application No. 63/109,648 filed on Nov. 4, 2020, the whole content of this application being incorporated herein by reference for all purposes.

### TECHNICAL FIELD

This invention relates to certain microporous articles comprising certain PEDEK-PEEK copolymers, to a method for making said microporous articles, in particular to a method of making microporous articles from a blend comprising said PEDEK-PEEK copolymer and at least one additional polymer, comprising processing said blend into a film and treating the film with a solvent for obtaining the microporous article.

### BACKGROUND ART

Poly(arylether ketones) (PAEK), including notably poly(etheretherketone), or PEEK, displays advantageous chemical and physical properties for many uses. The high melting point, high glass transition temperature, low solubility and high chemical resistance make PAEKs the materials of choice for separations applications for harsh environments.

PAEKs are not known to be affected by common organic solvents at room temperature. PAEKs are also generally known to be resistant to acids and bases with the exception of strong acids in high concentrations. The general insolubility of PAEKs, while a useful and advantageous attribute for extending fields of use of PAEKs, including under the form of porous membranes, such insolubility complicates significantly the formation of useful articles including porous membranes from.

Indeed, polymer film useful as ultrafiltration membranes and reverse osmosis membrane supports are traditionally formed by dissolving the polymer in a solvent, casting the polymer solution on a support as a thin film, followed by coagulation of the polymer by immersion of the support and polymer film into a bath of liquid in which the polymer solvent is miscible, but which is not a solvent for the polymer.

Because of the difficulties, alternative approaches have been pursued for the manufacture of PAEK membranes, in particular for the manufacture of PEEK membranes; among such approaches, those were microporous membranes have been prepared by compounding one polymer with a polymeric pore forming additive so as to prepare films, from which the said additive is then leached out, have been suggested.

U.S. Pat. No. 5,064,580 discloses a method for preparing a microporous membrane from poly(ether ether ketone) (PEEK) polymers and a plasticizer, which is capable of dissolving at least a portion of the PEEK polymer at the extrusion or casting temperature. The method comprises a step consisting in leaching the membranes to remove at least a portion of the plasticizer.

U.S. Pat. No. 4,721,732 discloses methods of making porous membranes by leaching (partially or entirely) a soluble component from a part made from a blend of miscible polymers; among the blends, mention is specifically made of polyetherimide and poly(aryl ether ketones) blends. In particular mixtures of PEI and PEEK are exemplified for manufacturing films which, after leaching with DMF, provides for membranes with average pore size of 0.03 μm and max size pores of 0.07 μm.

U.S. Pat. No. 6,887,408 discloses a process for the preparation of porous articles of poly(aryletherketone) (PAEK), with PEEK/PEI blends being specifically addressed. The process comprises forming the PEEK/PEI blend, forming a shaped article from the blend by extrusion, molding or casting, decomposing the PEI into low molecular weight fragments in the shaped article by chemical treatment by action of certain organic bases, and removing the low molecular weight fragments from the article. Chemical reagents that removed the PEI fragments include for example ammonia, hydrazine, N-Methyl-2-pyrrolidone (NMP), N,N-dimethyl formamide (DMF), and the like.

On the other side, while polyether ether ketone (PEEK), having characterizing recurring unit of formula —O-Ph-O-Ph-CO-Ph-, with Ph=para-phenylene, has found broad utility, including as constituent material of microporous membranes, its glass transition temperature of about 148° C. is somewhat limiting its ability for membranes made therefrom to withstand continuous operations at temperatures of 150° C. or beyond.

Among known polyaryl ether ketones (PAEKs) having increased glass transition temperatures, copolymers comprising a mixture of units —O-Ph-O-Ph-CO-Ph-(I) and —O-Ph-Ph-O-Ph-CO-Ph- (II) have been reported.

Notably, EP 0184458 A (ICI PLC) 11 Jun. 1986 is directed to aromatic polyetherketones containing the repeat units: —O-Ph-O-Ph-CO-Ph- (I) and —O-Ph-Ph-O-Ph-CO-Ph-(II) in the relative molar proportions 1:11 of 95:5 to 60:40, preferably 90:10 to 60:40, which are disclosed as possessing similar properties as known PAEKs materials (e.g. PEK or PEEK), but enabling processing at lower temperature.

Still, WO 2016/042492 (GHARDA CHEMICALS LIMITED) 24 Mar. 2016 discloses notably certain polyarylether ketones manufactured from 4,4′-difluorobenzophenone and a mixture of biphenol and hydroquinone, in molar ratios 95:5 to 5:95, as well as copolymers of PEK and PEDEK, including units of formula -Ph-CO-Ph-O— and units of formula -Ph-Ph-O-Ph-CO-Ph-O—, in variable molar ratios, as random or block copolymers.

Copolymers having units —O-Ph-O-Ph-CO-Ph- (I) and —O-Ph-Ph-O-Ph-CO-Ph-(II) with a molar ratio 1:11 of 45:55 to 15:85, i.e. including a majority of —O-Ph-Ph-O-Ph-CO-Ph-(II) units are notably known from WO2018/0086873 (Solvay Specialty Polymers USA, LLC) 1 Feb. 2018.

It is noticeable mentioning that the concept of transforming PEDEK-PEEK copolymers into membranes has been already generally described in US2019/0241712 (Solvay Specialty Polymers USA, LLC) 1 Feb. 2018, which teaches a method of forming a porous polymer membrane, comprising preparing a blend including a polymer which can be a poly(aryl ether ketone) (PAEK), and notably a PEDEK-PEEK copolymer, and an additive of formula Rₐ—Ar—X_{b} [Ar being an aromatic moiety which may have substituents R; and X being (SO₃⁻), (M^{p+})_{1/p} or (COO⁻), (M^{p+})_{1/p} in which M^{p+} is a metal cation of p valence; and b being an integer ranging from 1 to 4], processing said blend into a membrane, and immersing the membrane into water.

There is hence a continuous quest in the art for convenient methods for making membranes, and membranes therefrom, which are made of polyaryl ether ketone polymers other than PEEK, such membranes possessing an advantageous combination of thermal rating/thermal performances and chemical resistance, while maintaining outstanding mechanical performances, so as to provide membranes suitable for being used in extremely demanding application.

### SUMMARY OF INVENTION

An object of the present invention is to provide a microporous article, for example a flat membrane or a hollow fiber, said microporous article comprising a PEDEK-PEEK-type copolymer, presenting valuable thermal properties, mechanical properties (i.e. stiffness to prevent pore collapse), chemical resistance and known to be insoluble in most common solvents.

Another object of the present invention is to provide a convenient and efficient method for the preparation of said microporous article.

The Applicant has surprisingly found that the peculiar crystallization behavior of PEDEK-PEEK-type copolymers is such to enable manufacture microporous articles possessing peculiar porous dimensions and properties, and to enable their manufacture through a convenient and efficient method, with reduced annealing burden.

### DESCRIPTION OF EMBODIMENTS

As said a first object of the present invention is a microporous article comprising at least one polyaryl ether ketone copolymer [copolymer (PEDEK-PEEK)] comprising:
recurring units (R_{PEEK}) of formula (I):

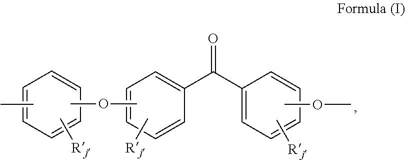

and
recurring units (R_{PEDEK}) of formula (II):

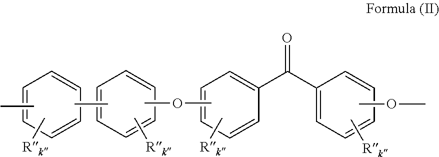

wherein in above formulae (I) and (II), each of R′ and R″, equal to or different from each other, is independently selected at each occurrence from a C₁-C₁₂ group optionally comprising one or more than one heteroatoms; sulfonic acid and sulfonate groups; phosphonic acid and phosphonate groups; amine and quaternary ammonium groups; each of j′ and k″, equal to or different from each other, is independently selected at each occurrence from 0 and an integer of 1 to 4;
wherein the said recurring units are comprised in a molar ratio (R_{PEDEK}):(R_{PEEK}) of 55:45 to 99:1,
said microporous article having a mean flow pore diameter (MFD), as determined according to ASTM F316-03, of at least 0.005 to at most 0.500 μm.

Another object of the present invention is a method for making said microporous article; according to one embodiment, this method comprises a step consisting in processing a polymer composition comprising copolymer (PEDEK-PEEK), as above described, and at least one additional polymer [polymer (P)] into an article; a step of thermal treating said article, under conditions to cause at least partial crystallization of the copolymer (PEDEK-PEEK), and a step consisting in removing at least partially said polymer (P) by contacting the article with a solvent for said miscible polymer, so as to obtain the microporous article.

The Microporous Article

A first object of the invention is hence a microporous article comprising a copolymer (PEDEK-PEEK), as above detailed.

The term “microporous article” is porous, i.e. it possesses well-defined porosity, that is to say it is an article comprising pores.

Microporous articles can be generally characterized by their mean flow pore diameter and the porosity, i.e. the fraction of the total article that is porous.

The microporous article advantageously possesses a gravimetric porosity (εₘ) of 20 to 95% v/v, preferably of 40 to 90% v/v, more preferably of 50 to 85% v/v, even more preferably of 55 to 80% v/v.

As explained, the term “gravimetric porosity” is intended to denote the volume fraction of voids over the total volume of the porous membrane.

Suitable techniques for the determination of the gravimetric porosity in the porous membranes of the invention are described for instance in SMOLDERS K., et al. Terminology for membrane distillation. Desalination. 1989, vol. 72, p. 249-262.

As said, said microporous article has a mean flow pore diameter (MFD), as determined according to ASTM F316-03, of at least 0.005 to at most 0.500 μm, preferably of at least 0.008 μm, more preferably at least 0.010 μm, even more preferably at least 0.020 μm; and/or or preferably of at most 0.250 μm, more preferably of at most 0.150 μm, even more preferably of at most 0.100 μm.

Advantageously, the microporous article of the invention is endowed with a narrow distribution of pores sizes, which is particularly advantageous for its filtration/separation performances. It is generally known that bubble point diameter (BPD) is representative of the largest pore opening within the membrane. Hence, the ratio BDP/MFD is of significance for describing the distribution of pores sizes in the microporous article of the invention. Accordingly, in particular, the microporous article of the invention possesses a distribution of pores sizes such that the ratio between the bubble point diameter (BPD) and the mean flow pore diameter (MFD) (ratio BDP/MFD) is of less than 4.0, preferably less than 3.5, more preferably less than 3.0, with BDP and MFD being determined according ASTM F316-03.

The microporous article of the invention is generally a porous membrane, that is to say a discrete, generally thin, interface that moderates the permeation of chemical species in contact with it. This interface may be molecularly homogeneous, that is, completely uniform in structure (dense membrane), or it may be chemically or physically heterogeneous, for example containing voids, holes or pores of finite dimensions (porous membrane).

Membranes having a uniform structure throughout their thickness, containing pores homogeneously distributed throughout their thickness are generally known as symmetric (or isotropic) membranes; membranes having pores which are not homogeneously distributed throughout their thickness are generally known as asymmetric membranes. Asymmetric membranes may include a thin selective layer (0.1-1 μm thick) and a highly porous thick layer (100-200 μm thick) which acts as a support and has little effect on the separation characteristics of the membrane.

The porous membrane of the invention may be either a symmetric membrane or an asymmetric membrane.

The porous membrane of the invention typically possesses a gravimetric porosity (εm) comprised between 20 to 95% v/v, preferably 40 to 90% v/v, more preferably 50 to 85% v/v, even more preferably 55 to 80% v/v.

The porous membrane of the invention may be either a self-standing porous membrane or can be assembled in a multi-layer assembly.

When assembled into a multi-layer assembly, the porous membrane of the invention may be notably supported onto a substrate layer, which may be partially or fully interpenetrated by the porous membrane of the invention, or may be not interpenetrated.

The nature of the substrate is not particularly limited. The substrate generally consists of materials having a minimal influence on the selectivity of the porous membrane. The substrate layer preferably consists of non-woven materials, glass fibres and/or polymeric material such as for example polypropylene, polyethylene and polyethyleneterephthalate.

Membranes can be in the form of a flat sheet or in the form of tubes.

Tubular membranes are classified based on their dimensions in:
tubular membranes having a diameter greater than 3 mm;
capillary membranes, having a diameter comprised between 0.5 mm and 3 mm; and
hollow fibres having a diameter of less than 0.5 mm. Oftentimes capillary membranes are also referred to as hollow fibres.

Flat sheet membranes are generally preferred when high fluxes are required whereas hollow fibres are particularly advantageous in applications where compact modules with high surface areas are required.

Thickness of the porous membrane of the invention can be tuned depending on the target field of use. Generally, porous membranes of the invention possess a thickness of at least 10 μm, preferably of at least 15 μm, more preferably at least 20 μm, and/or of at most 500 μm, preferably at most 350 μm, even more preferably at most 250 μm.

The microporous article of the invention generally possesses a water flux permeability, at a pressure of 1 bar and at a temperature of 23° C., of at least 5, preferably at least 10, more preferably at least 15 I/(h×m²).

Further, the microporous article of the invention have outstanding mechanical properties, in particular, it possesses a tensile modulus of exceeding 250 MPa, preferably of exceeding 300 MPa, more preferably of exceeding 350 MPa, when determined at room temperature (23° C.), according to ASTM D638.

Suprisingly, the microporous articles of the invention, comprising copolymer (PEDEK-PEEK) are endowed with ambient temperature tensile properties which are significantly improved over those of corresponding, otherwise similar, microporous articles comprising homopolymer (PEEK). This is particularly unexpected, as base constituting materials (copolymer (PEDEK-PEEK) and homopolymer (PEEK)) are otherwise known for possessing substantially similar ambient temperature mechanical performances, when these materials are assessed in the form of injection molding specimens.

Without being bound by this theory, the Applicant believes that the peculiar crystallization behaviour of copolymer (PEDEK-PEEK) may be responsible for ensuring such improved performances, rendering the said copolymer (PEDEK-PEEK) able to develop significant crystallinity, including during methods of making the microporous article (including the method described below), so as to achieve such advantageous mechanical performances, which are otherwise not accessible when homopolymer (PEEK) is processed into microporous membranes.

The microporous article comprises at least one polyaryl ether ketone copolymer [copolymer (PEDEK-PEEK)]; the said microporous article comprises said copolymer (PEDEK-PEEK) as main constituting element.

The microporous article may comprise additional constituting elements, although the amount of copolymer (PEDEK-PEEK) is of at least 60 wt. %, preferably at least 70 wt. %, more preferably at least 80 wt. %, even more preferably at least 85 wt. %, with respect to the total weight of the said microporous article.

The microporous article may additionally comprise other constituting ingredients, other than the copolymer (PEDEK-PEEK); notably, the microporous article may comprise additives, fillers, stabilizers, colorants, and the like.

It is generally understood that the said microporous article may comprise residues derived from the template leaching method used for its manufacture. Hence, it may be that the microporous article may comprise in addition to major amounts of copolymer (PEDEK-PEEK), minor amounts of polymer (P), as below detailed.

Generally, the said microporous article comprises an amount of polymer (P) in an amount of at most 15 wt. %, preferably at most of 12 wt. %, more preferably at most 10 wt. %, with respect to the total weight of the microporous article.

According to certain preferred embodiments, the microporous article is essentially consisting of a major amount of copolymer (PEDEK-PEEK) and a minor amount of polymer (P), being understood that minor quantities, generally of at most 1 wt. % (with respect to the total weight of the microporous article) of other ingredients, impurities or spurious ingredients may be tolerated, provided that they do not substantially modify the advantageous attributes of the microporous article.

The Copolymer (PEDEK-PEEK)

The copolymer (PEDEK-PEEK) comprises recurring units (R_{PEDEK}) and (R_{PEEK}) as above detailed in molar ratio (R_{PEDEK}):(R_{PEEK}) of 55:45 to 99:1, preferably of 60:40 to 95:5, more preferably of 65:35 to 90:10, and even more preferably of 68:32 to 80:20. Copolymers (PEDEK-PEEK) which have been found particularly advantageous are those comprising recurring units (R_{PEDEK}) and (R_{PEEK}) as above detailed in molar ratio of (R_{PEDEK}):(R_{PEEK}) of 70:30 to 80:20.

In copolymer (PEDEK-PEEK), the sum of the amount of recurring units (R_{PEDEK}) and (R_{PEEK}) is generally of at least 70% moles, preferably at least 80% moles, even more preferably at least 90% moles, and most preferably at least 95% moles, with respect to the total number of moles of recurring units.

The copolymer (PEDEK-PEEK) may additionally comprise recurring units (R_{PAEK}) different from recurring units (R_{PEEK}) and (R_{PEDEK}), as above detailed. In such case, the amount of recurring units (R_{PAEK}) is generally comprised between 0 and 5% moles, with respect to the total number of moles of recurring units of copolymer (PEDEK-PEEK), while recurring units (R_{PEEK}) and (R_{PEDEK}) will be present in an amount of at least 95% moles, with respect to the total number of moles of recurring units of copolymer (PEDEK-PEEK).

When recurring units (R_{PAEK}) different from recurring units (R_{PEEK}) and (R_{PEDEK}) are present in the copolymer (PEDEK-PEEK), these recurring units (R_{PAEK}) generally comply with any of the following formulae (K-A) to (K-M) herein below:

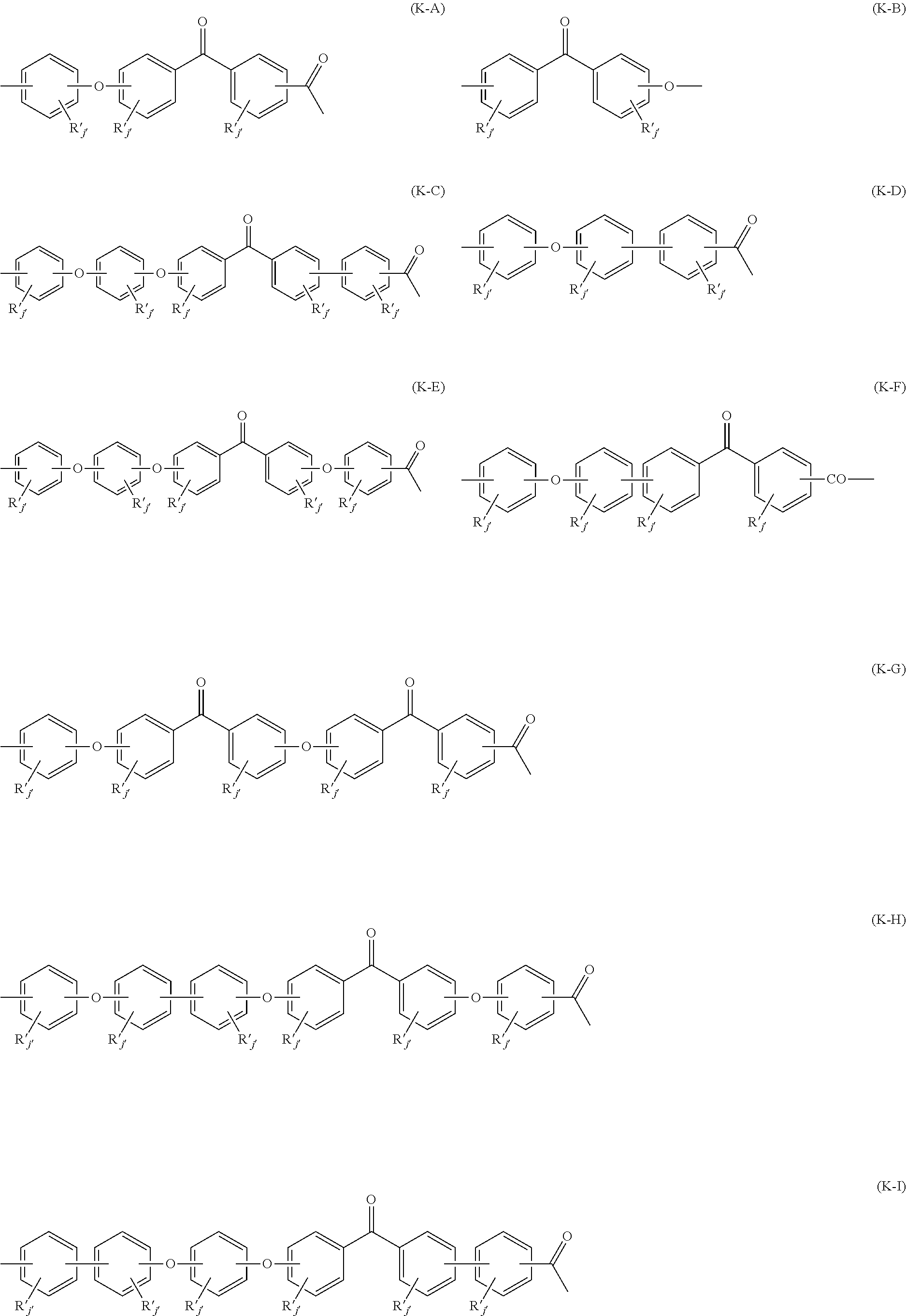

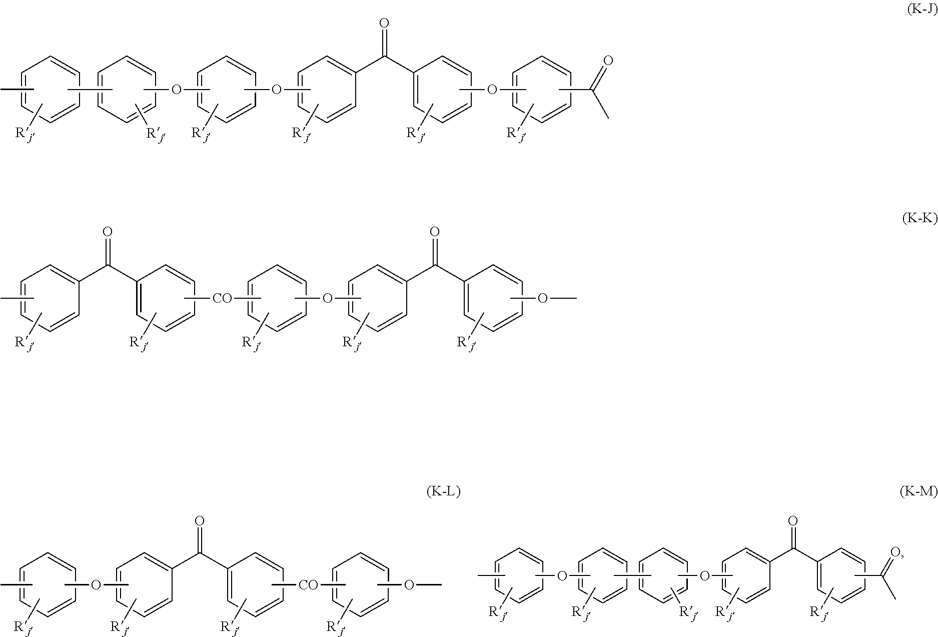

wherein in each of formulae (K-A) to (K-M) above, each of R′, equal to or different from each other, is independently selected at each occurrence from a C₁-C₁₂ group optionally comprising one or more than one heteroatoms; sulfonic acid and sulfonate groups; phosphonic acid and phosphonate groups; amine and quaternary ammonium groups; and each of j′, equal to or different from each other, is independently selected at each occurrence from 0 and an integer of 1 to 4, preferably j′ being equal to zero.

It is nevertheless generally preferred for the copolymer (PEDEK-PEEK) to be essentially composed of recurring units (R_{PEEK}) and (R_{PEDEK}), as above detailed. The expression “essentially composed of”, in connection with copolymer (PEDEK-PEEK) is meant to indicate that defects, end groups and monomers' impurities may be incorporated in very minor amounts (e.g. of less than 1 wt. %) in the copolymer (PEDEK-PEEK), so as to advantageously not affect negatively the performances of the same in the inventive blend.

In recurring units (R_{PEEK}) of formula (I), the connections among phenyl groups are generally in the para positions of each of the phenyl rings. Further, it is generally preferred for each of j′ to be zero, or in other words, for each of the phenyl rings not to bear any further substituents in addition to the catenary ethereal or ketone bridging groups. According to these preferred embodiments, recurring units (R_{PEEK}) comply with formula (Ia):

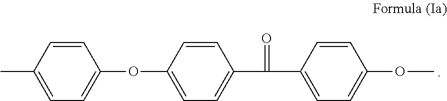

Similarly, in recurring units (R_{PEDEK}) of formula (II), the connections among phenyl groups are generally in the para positions of each of the phenyl rings. Further, it is generally preferred for each of k″ to be zero, or in other words, for each of the phenyl rings not to bear any further substituents in addition to the catenary ethereal or ketone bridging groups. According to these preferred embodiments, recurring units (R_{PEDEK}) comply with formula (IIb):

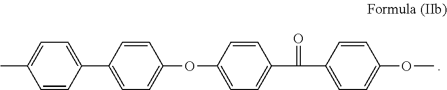

The Method of Making the Microporous Article

The microporous article of the invention is advantageously manufactured by the method of the invention, as above detailed.

As said above, the method for making said microporous article comprises:
Step 1.—a step consisting in processing a polymer composition comprising copolymer (PEDEK-PEEK), as above described, and at least one additional polymer [polymer (P)] into a solid article;
Step 2.—a step of thermal treating said solid article, under conditions to cause at least partial crystallization of the copolymer (PEDEK-PEEK), and
Step 3.—a step consisting in removing at least partially said polymer (P) by contacting the thermally treated article obtained from Step 2. with a solvent for said polymer (P), so as to obtain the microporous article.

Step 1 is a step consisting of processing a polymer composition [composition (C)] into an article; this step generally consists in processing said composition (C) from the molten phase.

Melt forming is commonly used to process said composition (C) into an article by film extrusion, preferably by flat cast film extrusion or by blown film extrusion.

Composition (C) is first prepared by melt compounding by mixing said copolymer (PEDEK-PEEK) and said polymer (P). Generally, melt compounding is carried out in an extruder. Composition (C) is typically extruded through a die at temperatures generally beyond the melting point of copolymer (PEDEK-PEEK), thereby providing strands which are typically cut thereby providing pellets. According to this technique, composition (C) is extruded through a die so as to obtain a molten tape, which is then calibrated and stretched in the two directions until obtaining the required thickness and wideness. Twin screw extruders are preferred devices for accomplishing melt compounding to provide for composition (C).

In Step 1., as said, composition (C) is processed by melt forming.

Melt forming is commonly used to process said composition (C) into an article by film extrusion, preferably by flat cast film extrusion or by blown film extrusion.

In flat film or sheet production the first objective is to spread a continuous melt stream of composition (C) coming from an extruder into a die, having a wide cross-section, and a small gap, typically a rectangular die. Once exited from the die, the molten extrudate of composition (C) is contacted on rollers (which may be cooled or heated) and solidifies so as to provide for a solid article.

In this Step 1., the molten extrudate so obtained may be stretched either in molten phase or after its solidification upon cooling, for delivering the solid article. Hot blown film extrusion can also be used to provide for said solid article.

The Polymer (P)

As said, Step 1. Is a step consisting in processing a polymer composition comprising copolymer (PEDEK-PEEK), as above described, and at least one additional polymer, referred to as polymer (P). The choice of polymer (P) will be made by one of ordinary skills in the art considering solubility differentiation which is required in the method of the present invention.

In view of solubility requirements, polymer (P) will be advantageously selected from amorphous polymers, i.e. from polymers having a heat of fusion of less than 5 J/g. Yet, embodiments whereas the polymer (P) possesses a semi-crystalline character are still possible.

Generally, polymer (P) will be selected among those who are capable of forming homogeneous or compatible blends with copolymer (PEDEK-PEEK) as detailed above.

It is generally admitted that polymer blends can be broadly divided into three categories:
1. Immiscible or heterogeneous polymer blends, whereas the constituent polymers exist in separate phases and the respective glass transition temperatures are observed;
2. Compatible polymer blends, which are immiscible polymer blends that exhibit macroscopically uniform physical properties, caused by sufficiently strong interactions between the component polymers.
3. Miscible or homogeneous polymer blends, which have a single-phase structure, possessing one glass transition temperature.

According to certain embodiments, polymer (P) is selected from polymers which can form compatible blends with copolymer (PEDEK-PEEK), i.e. from polymers which, although not completely miscible, eliminate the potential complicating factors associated with many heterogeneous two-phase blends which can exhibit unstable and variable phase domain sizes and morphology which often translate to variability in physical and mechanical properties of the blend. In such case, compatibility may result in partial miscibility, still providing for distinguished amorphous phases, but with T_{g} modified from the major constituting single polymer component (polymer (P) or copolymer (PEDEK-PEEK)), being understood that individual polymers may have both an amorphous portion and a crystalline portion where any crystalline portion may exist as a separate phase.

According to other embodiments, polymer (P) is selected from polymers which can form miscible blends, i.e. polymers (P) which, when combined with copolymer (PEDEK-PEEK), provides for blends having a single amorphous phase exhibits a single glass transition temperature.

The polymer (P) is advantageously at least one of poly(ether imide); this said, alternative polymers may be poly(arylether ketone)s different from copolymer (PEDEK-PEEK), such as notably PEK (i.e. a polymer having units (K-B) as described above) or PEKEKK (i.e. a polymer having units (K-G), as described above).

Poly(Ether Imide) [Polymer (PEI)]

As said, according to certain preferred embodiments, the polymer (P) is a poly(ether imide) [polymer (PEI)]. The expressions “poly(ether imide)” and/or “polymer (PEI)” denotes a polymer comprising at least 50 mol. %, based on the total number of moles in the polymer, of recurring units (R_{PEI}) comprising at least one aromatic ring, at least one imide group, as such and/or in its amic acid form, and at least one ether group. Recurring units (R_{PEI}) may optionally further comprise at least one amide group which is not included in the amic acid form of an imide group.

Generally, the recurring units (R_{PEI}) are selected from the group consisting of following formulas (I), (II), (III), (IV), (V) and mixtures thereof:

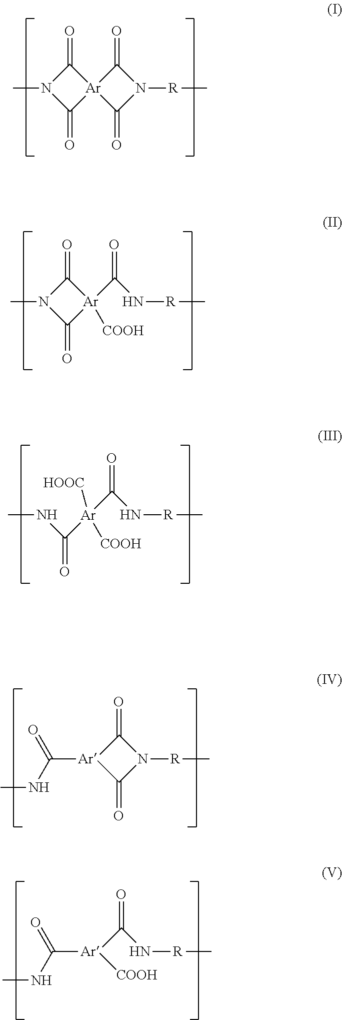

where
   Ar is a tetravalent aromatic moiety and is selected from the group consisting of a substituted or unsubstituted, saturated, unsaturated or aromatic monocyclic and polycyclic group having 5 to 50 carbon atoms;
   Ar′ is a trivalent aromatic moiety and is selected from the group consisting of a substituted, unsubstituted, saturated, unsaturated, aromatic monocyclic and aromatic polycyclic group having from 5 to 50 C atoms; and
   R is selected from the group consisting of substituted and unsubstituted divalent organic radicals, for example selected from the group consisting of
(a) aromatic hydrocarbon radicals having 6 to 20 carbon atoms and halogenated derivatives thereof;
(b) straight or branched chain alkylene radicals having 2 to 20 carbon atoms;
(c) cycloalkylene radicals having 3 to 20 carbon atoms, and
(d) divalent radicals of formula (VI):

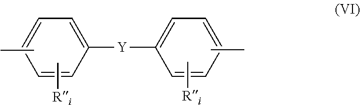

where
   Y is selected from the group consisting of alkylenes of 1 to 6 carbon atoms, for example —C(CH₃)₂ and —CₙH₂ₙ— (n being an integer from 1 to 6); perfluoroalkylenes of 1 to 6 carbon atoms, for example —C(CF₃)₂ and —Cₙ F₂ₙ— (n being an integer from 1 to 6); cycloalkylenes of 4 to 8 carbon atoms; alkylidenes of 1 to 6 carbon atoms; cycloalkylidenes of 4 to 8 carbon atoms; —O—; —S—; —C(O)—; —SO₂—; —SO—, and
R″ is selected from the group consisting of hydrogen, halogen, alkyl, alkenyl, alkynyl, aryl, ether, thioether, carboxylic acid, ester, amide, imide, alkali earth metal sulfonate, alkaline earth metal sulfonate, alkyl sulfonate, alkali earth metal phosphonate, alkaline earth metal phosphonate, alkyl phosphonate, amine and quaternary ammonium and
i, for each R″, is independently zero or an integer ranging from 1 to 4, with the proviso that at least one of Ar, Ar′ and R comprise at least one ether group and that the ether group is present in the polymer chain backbone.

In above formulae, Ar is typically selected from the group consisting of formulae:

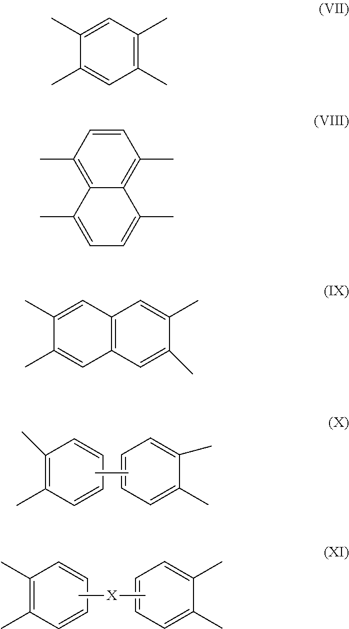

where

X is a divalent moiety, having divalent bonds in the 3,3′, 3,4′, 4,3″ or the 4,4′ positions and is selected from the group consisting of alkylenes of 1 to 6 carbon atoms, for example —C(CH₃)₂ and —CₙH₂ₙ— (n being an integer from 1 to 6); perfluoroalkylenes of 1 to 6 carbon atoms, for example —C(CF₃)₂ and —CₙF₂ₙ— (n being an integer from 1 to 6); cycloalkylenes of 4 to 8 carbon atoms; alkylidenes of 1 to 6 carbon atoms; cycloalkylidenes of 4 to 8 carbon atoms; —O—; —S—; —C(O)—; —SO₂—; —SO—;
or X is a group of the formula —O—Ar″—O—, wherein Ar″ is a aromatic moiety selected from the group consisting of a substituted or unsubstituted, saturated, unsaturated or aromatic monocyclic and polycyclic group having 5 to 50 carbon atoms.

In above formulae, Ar′ is typically selected from the group consisting of formulae:

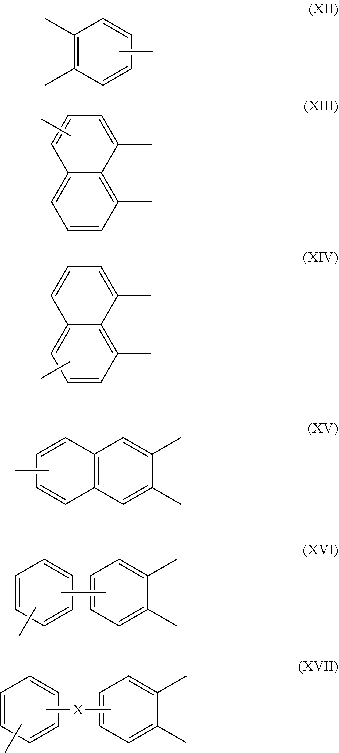

where
X is a divalent moiety, having divalent bonds in the 3,3′, 3,4′, 4,3″ or the 4,4′ positions and is selected from the group consisting of alkylenes of 1 to 6 carbon atoms, for example —C(CH₃)₂ and —CₙH₂ₙ— (n being an integer from 1 to 6); perfluoroalkylenes of 1 to 6 carbon atoms, for example —C(CF₃)₂ and —CₙF₂ₙ— (n being an integer from 1 to 6); cycloalkylenes of 4 to 8 carbon atoms; alkylidenes of 1 to 6 carbon atoms; cycloalkylidenes of 4 to 8 carbon atoms; —O—; —S—; —C(O)—; —SO₂—; —SO—;
or X is a group of the formula —O—Ar″—O—, wherein Ar″ is a aromatic moiety selected from the group consisting of a substituted or unsubstituted, saturated, unsaturated or aromatic monocyclic and polycyclic group having 5 to 50 carbon atoms.

Generally, at least 50 mol. %, at least 60 mol. %, at least 70 mol. %, at least 80 mol. %, at least 90 mol. %, at least 95 mol. %, at least 99 mol. % or all of the recurring units in the polymer (PEI) are recurring units (R_{PEI}) of formulas (I), (II), (III), (IV), (V) and/or mixtures thereof, as defined above.

According to certain embodiment, polymer (PEI) is a polymer comprising at least 50 mol. %, based on the total number of moles in the polymer, of recurring units (R_{PEI}) of formula (VII):

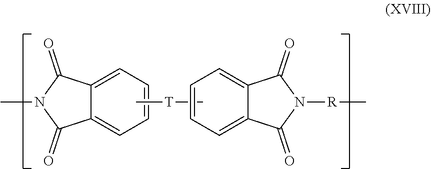

where
   R is selected from the group consisting of substituted and unsubstituted divalent organic radicals, for example selected from the group consisting of
(a) aromatic hydrocarbon radicals having 6 to 20 carbon atoms and halogenated derivatives thereof;
(b) straight or branched chain alkylene radicals having 2 to 20 carbon atoms;
(c) cycloalkylene radicals having 3 to 20 carbon atoms, and
(d) divalent radicals of formula (VI):

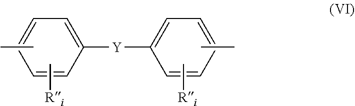

where
   Y is selected from the group consisting of alkylenes of 1 to 6 carbon atoms, for example —C(CH₃)₂ and —CₙH₂ₙ— (n being an integer from 1 to 6); perfluoroalkylenes of 1 to 6 carbon atoms, for example —C(CF₃)₂ and —Cₙ F₂ₙ— (n being an integer from 1 to 6); cycloalkylenes of 4 to 8 carbon atoms; alkylidenes of 1 to 6 carbon atoms; cycloalkylidenes of 4 to 8 carbon atoms; —O—; —S—; —C(O)—; —SO₂—; —SO—, and
   R″ is selected from the group consisting of hydrogen, halogen, alkyl, alkenyl, alkynyl, aryl, ether, thioether, carboxylic acid, ester, amide, imide, alkali earth metal sulfonate, alkaline earth metal sulfonate, alkyl sulfonate, alkali earth metal phosphonate, alkaline earth metal phosphonate, alkyl phosphonate, amine and quaternary ammonium and
   i, for each R″, is independently zero or an integer ranging from 1 to 4,
   T can either be
   —O— or —O—Ar″—O—
wherein the divalent bonds of the —O— or the —O—Ar″—O— group can be in the 3,3′, 3,4′, 4,3′, or the 4,4′ positions, wherein Ar″ is a aromatic moiety selected from the group consisting of a substituted or unsubstituted, saturated, unsaturated or aromatic monocyclic and polycyclic group having 5 to 50 carbon atoms, for example a substituted or unsubtitutated phenylene, a substituted or unsubtitutated cyclohexyl group, a substitued or unsubstituted biphenyl group, a susbtituted or unsubstituted naphtalene group or a moiety comprising two substituted or unsubtitutated phenylene.

According to an embodiment of the present disclosure, Ar″ is of the general formula (VI), as detailed above; for example, Ar″ is of formula (XIX):

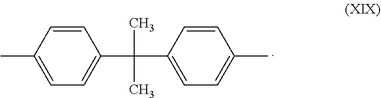

The polymer (PEI) according to is preferred embodiment may be prepared by any of the methods well-known to those skilled in the art including the reaction of a diamino compound of the formula H₂N—R—NH₂ (XX), where R is as defined before, with any aromatic bis(ether anhydride)s of the formula (XXI):

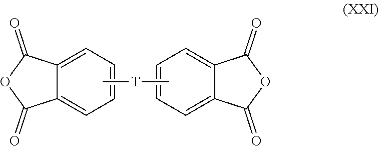

where T as defined before.

In general, the preparation can be carried out in solvents, e.g., o-dichlorobenzene, m-cresol/toluene, N,N-dimethylacetamide, at temperatures ranging from 20° C. to 250° C.

Alternatively, these polymer (PEI) can be prepared by melt polymerization of any dianhydrides of formula (XXI) with any diamino compound of formula (XX) while heating the mixture of the ingredients at elevated temperatures with concurrent intermixing.

The aromatic bis(ether anhydride)s of formula (XXI) include, for example:
2,2-bis[4-(2,3-dicarboxyphenoxy)phenyl]propane dianhydride;
4,4′-bis(2,3-dicarboxyphenoxy)diphenyl ether dianhydride;
1,3-bis(2,3-dicarboxyphenoxy)benzene dianhydride;
4,4′-bis(2,3-dicarboxyphenoxy)diphenyl sulfide dianhydride;
1,4-bis(2,3-dicarboxyphenoxy)benzene dianhydride;
4,4′-bis(2,3-dicarboxyphenoxy)benzophenone dianhydride;
4,4′-bis(2,3-dicarboxyphenoxy)diphenyl sulfone dianhydride;
2,2-bis[4 (3,4-dicarboxyphenoxy)phenyl]propane dianhydride;
4,4′-bis(3,4-dicarboxyphenoxy)diphenyl ether dianhydride;
4,4′-bis(3,4-dicarboxyphenoxy)diphenyl sulfide dianhydride;
1,3-bis(3,4-dicarboxyphenoxy)benzene dianhydride;
1,4-bis(3,4-dicarboxyphenoxy)benzene dianhydride;
4,4′-bis(3,4-dicarboxyphenoxy)benzophenone dianhydride;
4-(2,3-dicarboxyphenoxy)-4′-(3,4-dicarboxyphenoxy)diphenyl-2,2-propane dianhydride; and mixtures of such dianhydrides.

The organic diamines of formula (XX) are chosen from the group consisting of m-phenylenediamine, p-phenylenediamine, 2,2-bis(p-aminophenyl)propane, 4,4′-diaminodiphenyl-methane, 4,4′-diaminodiphenyl sulfide, 4,4′-diamino diphenyl sulfone, 4,4′-diaminodiphenyl ether, 1,5-diaminonaphthalene, 3,3′-dimethylbenzidine, 3,3′-dimethoxybenzidine, and mixtures thereof; preferably, the organic diamines of formula (XX) are chosen from the group consisting of m-phenylenediamine and p-phenylenediamine and mixture thereof.

According to certain preferred embodiments, polymer (PEI) is a polymer comprising at least 50 mol. %, based on the total number of moles in the polymer, of recurring units (R_{PEI}) of formulas (XXIII) or (XXIV), in imide forms, or their corresponding amic acid forms and mixtures thereof:

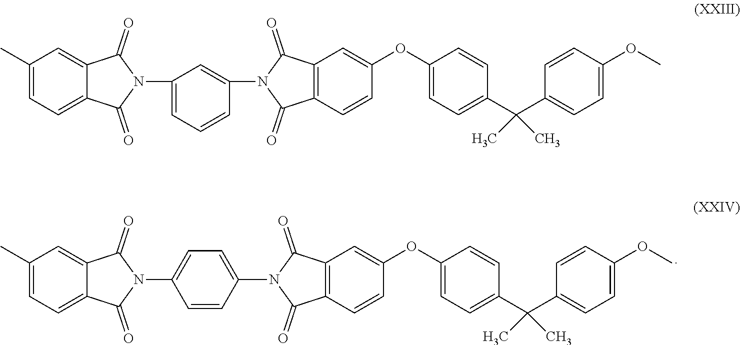

In a preferred embodiment, at least 50 mol. %, at least 60 mol. %, at least 70 mol. %, at least 80 mol. %, at least 90 mol. %, at least 95 mol. %, at least 99 mol. % or all of the recurring units in the PEI are recurring units (R_{PEI}) of formulas (XXIII) or (XXIV), in imide forms, or their corresponding amic acid forms and mixtures thereof.

Such aromatic polyimides are notably commercially available from Sabic Innovative Plastics as ULTEM® polyetherimides.

The solid article obtained from Step 1. may comprise, in addition to the copolymer (PEDEK-PEEK) and the polymer (P), various additives which may be included in order to give any desired property to the non-leached polymer. For example, stabilizers, flame retardants, pigments, plasticizers, and the like can be present. Other polymers may also be added to give a desired property.

Nevertheless, it is generally preferred for the solid article obtained from Step 1. to essentially consist of copolymer (PEDEK-PEEK) and polymer (P), being understood that minor amounts, e.g. of less of 1 wt. % of other ingredients, including impurities or other spurious compounds, may be tolerated, without their presence affecting the overall performances of the said solid article.

The weight percent of the polymer (P), i.e. of the component to be leached out is generally in the amount of from about 10 wt. % to about 90 wt. %, preferably from about 30 wt. % to about 75 wt. %, more preferably from about 40 wt. % to about 70 wt. %, even more preferably from about 55 wt. % to about 68 wt. %, based on the combined weight of polymer (P) and copolymer (PEDEK-PEEK). Hence, conversely, the weight percent of the copolymer (PEDEK-PEEK), i.e. of the target constituent material of the microporous article is generally in the amount of from about 90 wt. % to about 10 wt. % and preferably from about 70 wt. % to about 25 wt. %, more preferably from about 60 wt. % to about 30 wt. %, even more preferably from about 45 wt. % to about 32 wt. %, based on the combined weight of polymer (P) and copolymer (PEDEK-PEEK).

In Step 2., a step of thermal treating said solid article, under conditions to cause at least partial crystallization of the copolymer (PEDEK-PEEK) is carried out.

As an outcome of this Step 2., the non-leachable polymer, i.e. the copolymer (PEDEK-PEEK) will be in a partly crystalline state. This has been found to be particularly advantageous in preparing microporous articles of this invention to reduce or control shrinkage of the pore size of the article. Indeed, differently from what is observed with homopolymers consisting of PEEK-type units only, the prominent features of copolymer (PEDEK-PEEK) are such that the said copolymer (PEDEK-PEEK) has advantageous crystallization ability, which makes it possible for said copolymer (PEDEK-PEEK) to quickly and significantly crystallize when in the presence of a miscible or compatible polymer (P).

Such peculiar crystalline behaviour is such to confer to the microporous membranes obtained from the annealed solid article of Step 2. very advantageous properties, including improved dimensional stability, improved mechanical properties.

Further, differently from the lengthy and severe thermal annealing conditions required for manufacturing PEEK membranes, according to similar procedure, the solid article can be thermal treated for shorter periods and at less severe (lower) conditions, rendering hence the overall method of making easier and more effective.

The thermal treatment of Step 2. is carried out at a temperature of at least 200° C., preferably of at least 250° C., more preferably of at least 280° C. and/or at a temperature of at most 370° C., preferably of at most 365° C., more preferably of at most 350° C.

The thermal treatment of Step 2. is carried out for a period of at least 1 minute, preferably at least 2 minutes, more preferably at least 3 minutes; and/or for a period of at most 120 minutes, preferably at most 60 minutes, more preferably at most 30 minutes.

As said, Step 3. of the method of the invention is a step consisting in removing at least partially said polymer (P) by contacting the thermally treated article obtained from Step 2. with a solvent for said polymer (P), so as to obtain the microporous article.

In Step 3. the thermally treated (aka “annealed”) article is treated with a solvent which is a solvent for the polymer (P) and a non-solvent for the copolymer (PEDEK-PEEK). At least a portion of the polymer (P) dissolves in the solvent and is removed on removal of the solvent. The polymer (P) soluble in the solvent is hence referred to as the leachable component and the polymer removed by the process is referred to as the polymer leached out or extracted from the article.

The annealed article is generally treated with a solvent which should not substantially dissolve, extract or leach copolymer (PEDEK-PEEK), i.e. it must be a “non-solvent” for said copolymer (PEDEK-PEEK). The non-solvent may, however, within the scope of the invention, cause the non-leached copolymer (PEDEK-PEEK) to swell while in said solvent. Further, it is within the scope of the invention that the non-solvent may remove low molecular weight fractions of the non-leached copolymer (PEDEK-PEEK).

Treatment with the solvent preferably takes place by immersing the annealed article in a bath containing the solvent. The annealed article is immersed in the bath for a period of time sufficient to remove the desired amount of the polymer (P). Generally, the annealed article will be maintained in contact with the solvent for about 1 minute to about 8 hours or more, preferably from about 10 minutes to about 4 hours. Alternatively the annealed article may be suspended in the vapors of the boiling solvent.

The temperature at which the solvent treatment step is carried out depends on the solvent used and the polymer (P) utilized. In most instances the solvent will be maintained at temperatures from about ambient temperature to about below the boiling point of the solvent.

Those skilled in the art will readily be able to select solvents which are non-solvents for copolymer (PEDEK-PEEK). For example, methylene chloride, dimethylacetamide (DMAC), dimethylformamide (DMF), N-methylpyrrolidone, as well as nontoxic solvents such as methyl I-lactate, ethyl lactate, propylene carbonate, tributyl o-acetylcitrate, tributyl citrate, triethyl phosphate, and y-butyrolactone (GBL) could be used to leach polymer (P).

With these regards, the essential lack of solubility of copolymer (PEDEK-PEEK) in almost all common organic solvents is an advantage.

When polymer (P) is polymer (PEI), N-methylpyrrolidone (NMP), methylene chloride and y-butyrolactone (GBL) are possible solvents, which can be used in Step 3.

In particular, when polymer (P) is polymer (PEI), methylene chloride at ambient temperature is an efficient solvent.

Generally, it is desirable to leach out substantially all of the soluble polymer (P) resulting in a microporous article having the physical and mechanical properties of the copolymer (PEDEK-PEEK).

In certain circumstances, however, it may be advantageous to leach out a portion only of the soluble polymer (P). Presence of the soluble polymer (P) can, for example, result in a microporous article of greater flexibility, greater wettability or the like than exhibited by a microporous article substantially free of the polymer (P).

Generally, however the final microporous article should contain no more than about 10 weight percent, based on the weight of the microporous article, of the polymer (P).

It is not necessary to remove the solvent to use the microporous articles of the invention. For example, a microporous article of the invention leached with dimethyl formamide (DMF) may be placed directly in an aqueous solution for filtration purposes without removal of the solvent involved. Optionally however, the solvent is removed from the article. The removal can be accomplished by continuous removal e.g. distillation while the microporous article is being treated by the solvent or subsequent to the completion of extraction by evaporation, vacuum, heat, filtration, freeze drying or any other technique known to one skilled in the art for removal of solvents.

Generally, after treatment with the solvent, the treating solvent and dissolved polymer (P) are removed from the microporous article by washing this latter with a second solvent. The second solvent is miscible with the first and on washing with the second solvent the treating solvent and dissolved polymer (P) are removed.

The microporous article can then be dried if desired to remove the second solvent. The selection of the second solvent depends on the first solvent used for leaching (and the nature of the polymer (P) component being leached from the shaped article). Isopropanol or mixtures of isopropanol and water have been found particularly effective, in particular for the removal of dichloromethylene/polymer (PEI) residues from the microporous membranes.

The microporous article of the invention are useful for filtration of particulate matter suspended in liquid and gas dispersions or suspensions.

They are especially useful in harsh environments, or where there is exposure to aggressive chemicals during filtration, or in the cleaning and maintenance of the filter devices comprising the same. The microporous articles of the invention may be used in many fields of use, including water purification purification of biological fluids, wastewater treatments, osmotic distillation, and process fluids filtration in the chemical industry.

The following examples are representative of the invention but are not intended to be limiting. Substitution of materials, and conditions which are obvious from this disclosure are with the contemplation of the invention.

Raw Materials

The copolymer (PEDEK-PEEK) used is a PEDEK-PEEK copolymer derived from the polycondensation of 4,4′-difluorobenzophenone (DFBP), 4,4′-dihydroxydiphenyl, also known as biphenol, and hydroquinone. The copolymer is rich in biphenol residue moieties relative to hydroquinone moieties within the total stoichiometric amount of the biphenol in the polymerization. PEDEK represents the polymer repeating unit from the polycondensation of biphenol with 4,4′-difluorobenzophenone. While copolymers (PEDEK-PEEK) that can be used in the practice of this invention can vary in the molar proportion of the PEDEK and PEEK repeat units within the polymer backbone, in the examples a copolymer possessing a PEDEK-PEEK mole ratio of 75-25 (PEDEK-PEEK copolymer, hereinafter) has been used. Said PEDEK-PEEK copolymer has a melt viscosity of 345 Pa s at 420° C. and 1000 s⁻¹ as measured using a capillary rheometer according to ASTM D3835.

The polymer (PEI) used was ULTEM® 1000 PEI from SABIC. This is a standard grade of PEI for general purpose extrusion and injection molding applications. The manufacturer reports that this grade has a melt flow rate of about 9 g/10 min as measured using a melt index apparatus according to ASTM D1238 at 377° C. and using a 6.6 kg weight.

### Preparative Example 1 (a)—Compounding of Copolymer (PEDEK-PEEK)/Polymer (PEI) Blend

The blend of copolymer (PEDEK-PEEK) and polymer (PEI) was prepared under the form of pellets by melt compounding using a 26 mm Coperion® co-rotating partially intermeshing twin screw extruder having an L/D ratio of 48:1. The extruder had 12 barrel sections with barrel sections 2 through 12 being heated with a temperature setting of 380° C. A 3-mm diameter pin-hole die was used, with a die temperature setting also of 380° C. The extruder was operated at a throughput rate of 30-35 lb/hr (about 13-14 kg/hr) and 225 rpm screw speed, and the extruder torque reading was maintained in the range of about 75-85% during compounding of all the compositions. Vacuum venting with a vacuum level >25 in Hg was applied at barrel section 10 during compounding to strip off moisture and any possible residual volatiles from the compound. The extrudate from each of the runs was stranded and cooled in a water trough and then pelletized into pellets approximately 2.7 mm in diameter and 3.0 mm in length.

A blend of copolymer (PEDEK-PEEK)/polymer (PEI) 35/65% wt was so prepared.

### Preparative Example 2C(a) (of Comparison)—Compounding of PEEK/Polymer (PEI) Blend

PEEK homopolymer resin used was KETASPIRE® KT-820 NL, under the form of pellets. Procedure followed for manufacturing the blend was the same as above described for the copolymer (PEDEK-PEEK)/polymer (PEI) blend, except with the following modifications. Barrel sections 2 through 7 were heated with a temperature setting of 370° C., and barrel sections 8 through 12 were heated with a temperature setting of 360° C. The die temperature setting was 375° C. Screw speed was 200 rpm. A blend of homopolymer PEEK/polymer (PEI) 35/65% wt was so prepared.

### Preparative Example 1(b)—Film (“Precursor”) Extrusion of Copolymer (PEDEK-PEEK)/Polymer (PEI) 35/65% Wt Blend

Pellets of the blend prepared as described in Ex. 1(a) were dried overnight at 150° C. before extrusion. Films were extruded using a Brabender single screw extruder having a diameter (D) of 19 mm and a length of 25 times said D, with four temperature zones (T1 to T4). The extruder was equipped with a head having a width of 10 cm and a thickness of 0.5 mm. Films were quenched with a chill roll at 150° C. at a distance of 0.5 cm from the extruder head. Extrusion conditions are detailed in table below.

TABLE 1
Film processing conditions for preparative example 1(b)

| | | |
|---|---|---|
| T1 | ° C. | 380 |
| T2 | ° C. | 400 |
| T3 | ° C. | 400 |
| T4 | ° C. | 400 |
| T melt (@ clamp) | ° C. | 403 |
| head pressure | bar | 35 |
| screw speed | rpm | 50 |
| torque | N/m | 22 |
| Roll Temp | ° C. | 150 |
| Line speed | m/min | 0.5 |
| flow rate | Kg/h | 1.1 |

### Preparative Example 2C(b)—Film (“Precursor”) Extrusion of Homopolymer (PEEK)/Polymer (PEI) 35/65% Wt Blend

Pellets of the blend prepared as detailed in Ex. 2C(a) were dried overnight at 150° C. before extrusion. Films were extruded using the same apparatus described in Ex. 1(b), except that they were quenched at 140° C. Extrusion conditions are detailed in table below.

TABLE 2
Film processing conditions for preparative example 2C(b)

| | | |
|---|---|---|
| T1 | ° C. | 290 |
| T2 | ° C. | 340 |
| T3 | ° C. | 340 |
| T4 | ° C. | 380 |
| T melt (@ clamp) | ° C. | 369 |
| head pressure | bar | 52-54 |
| screw speed | rpm | 50 |
| torque | N/m | 10-12 |
| Roll Temp | ° C. | 140 |
| Line speed | m/min | 0.5 |
| flow rate | Kg/h | 1.0 |

### Preparative Example 1(c) Film (“Precursor”) Annealing

Annealing of the film manufactured as described above was carried out in a ventilated oven.

The precursor films were heat treated at a temperature of 320° C. for a period of time of 30 minutes (condition “A”) or for a period of time of 5 minutes (condition “B”), so as to increase crystalline fraction, which may be measured notably by DSC.

### Preparative Example 2C(c) of Comparison—Film (“Precursor”) Annealing

Same procedure as described in ex. 1(c) was followed.

### Preparative Example 1(d)—Annealed Films Extraction to Get Porous Membranes

The annealed precursor films obtained as detailed in ex. 1(c) (conditions A & B) were immersed in a bath of dichloromethane (CH₂Cl₂) for a duration of three hours. Subsequently films were rinsed several times in isopropanol (IPA) to remove residual CH₂Cl₂. Finally microporous membranes so obtained were dried at room temperature in a fume hood.

### Preparative Example 2C(d) of Comparison—Annealed Film Extraction to Get Porous Membranes

The annealed precursor films obtained as detailed in ex. 2C(c) (conditions A & B) were treated as detailed in Ex. 1(d) above, so as to obtain microporous membranes.

Characterization of the Microporous Membranes

Determination of Residual Leachable Polymer (PEI) Content

Annealed precursor films were weighed before and after extraction of ex. 1(d) and 2C(d), as above detailed.

Residual weight was defined as:

Res(%)=(W_{fin}/Wᵢₙ)×100
where Wᵢₙ is the weight of the annealed film before CH₂Cl₂ extraction and W_{fin} is the weight of the microporous membrane after extraction.

A residual weight exceeding the nominal weight amount of copolymer (PEDEK-PEEK) of the original blend of examples 1(a) and 2C(a) was found as indicative of the presence of residual polymer (PEI).

Measurement of Permeability

Water flux (J) through microporous membranes, at given pressure, is defined as the volume which permeates per unit area and per unit time.

The flux was computed according to the following equation:

$$\\ J = \frac{V}{A Δ t}$$

wherein:
V (L) is the volume of permeate,
A (m²) is the membrane area, and
Δt (h) is the operation time.

Water flux measurements were conducted at room temperature using a dead-end configuration under a constant nitrogen pressure of 1 bar using pure MilliQ water. Membrane discs with an effective area of 11.3 cm2 were cut from the membrane sheets (previously immersed in IPA) and placed on a metal plate. For each material, flux is the average of at least five different discs. The flux is expressed in LMH (liters/[squared meter×hour]).

Measurement of Gravimetric Porosity

Gravimetric porosity (εₘ) of the membrane is defined as the volume of the pores divided by the total volume of the membrane.

Membrane gravimetric porosity (εₘ) was determined according to the gravimetric method detailed below.

Perfectly dry membrane pieces were weighed and impregnated in isopropyl alcohol (IPA) for 24 h. After this time, the excess of the liquid was removed with tissue paper, and membranes weight was measured again. The porosities were measured using IPA (isopropyl alcohol) as wetting fluid according to the procedure described in Appendix of Desalination, 72 (1989) 249-262.

$$\\ ε ( \% ) = \frac{\frac{( Wet - Dry )}{{ρ}_{liquid}}}{\frac{( Wet - Dry )}{{ρ}_{liquid}} - \frac{Dry}{{ρ}_{polymer}}} \times 100$$

where
‘Wet’ is the weight of the wetted membrane,
‘Dry’ is the weight of dry membrane,
ρ_{polymer} is the density of copolymer (PEDEK-PEEK) (1.28 g/cm³), for the microporous membrane obtained from ex. 1(d), and of homopolymer (PEEK) (1.30 g/cm³), for the microporous membrane obtained from ex. 2C(d),
ρ_{liquid} is the density of IPA (0.78 g/cm³).

Measurement of Tensile Properties

Mechanical properties of microporous membranes were assessed at room temperature (23° C.) following ASTM D 638 standard procedure (type V, grip distance=25.4 mm, initial length Lo=21.5 mm). The values determined are the averages of repeated measurements carried out on 5 specimens of each sample. Modulus, Strain at break and stress at break are detailed in table 3 below.

Pore Size Determination

Determination of bubble point diameter (i.e. corresponding to the size of largest pores), smallest pore sizes and mean flow pore sizes were determined following ASTM F0316 method, using a Capillary Flow Porometer “Porolux 1000” (Porometer-Belgium).

For each determination, membrane disk samples (diameter=25 mm) were initially fully wetted using Fluorinert® FC 43 liquid (which is a fluorinated fluid with a very low surface tension of 16 dyne/cm) for some hours and placed in the sample holder of the instrument. Inert gas (nitrogen) was fed to the sample with increasing pressure. Quoted values in table 4 are the average of repeated measurements performed on 3 different specimens.

As said, bubble point diameter (BPD) is the largest pore opening within the membrane. The mean flow pore diameter (MFD) is an average pore size calculated by the half dry method as described in ASTM F316-03. The ratio of these two quantities (BPD/MFD) is representative of the uniformity of the pore size distribution, the smaller such ratio, the more uniform the pore size distribution, and hence more favourable the filtration/separation performances of the microporous membrane.

Results are summarized in Tables below.

TABLE 3
Mechanical properties of microporous membranes

| | | | | Tensile Properties | | |
|---|---|---|---|---|---|---|
| | | | | | Strain | Stress |
| | | Thick- | | | at | at |
| | Annealing | ness | Flux | Modulus | break | break |
| | condition | (μm) | (LMH) | (MPa) | (%) | (MPa) |
| Ex. 1(d)-A | A | 395 | 69 | 403 | 6 | 12 |
| Ex. 1(d)-B | B | 282 | 80 | 382 | 6 | 10 |
| Ex 2C(d)-A | A | 372 | 69 | 173 | 3 | 3.8 |
| Ex 2C(d)-B | B | 338 | 28 | 201 | 10.4 | 8.1 |

TABLE 4
Pores size distribution of microporous membranes

| | Pore size | | | | | |
|---|---|---|---|---|---|---|
| | | | Smallest | | Residual | |
| | BPD | MFD | pore | BPD/ | weight | εₘ |
| | (nm) | (nm) | (nm) | MFD | (%) | (%) |
| Ex. 1(d)-A | 85 | 46 | 32 | 1.85 | 38 | 66 |
| Ex. 1(d)-B | 82 | 48 | 37 | 1.71 | 37 | 69 |
| Ex. 2C(d)-A | 73 | 42 | 34 | 1.74 | 38 | 68 |
| Ex. 2C(d)-B | 26 | ND* | ND* | ND* | 42 | 69 |

*ND = Not determined. Pores were found to have sizes smaller than 26 nm (limit of detection), and hence too small for significant measurement, as requiring excessive pressure for their determination.

Tables 3 and 4 above clearly demonstrate that short annealing times, which are highly preferred when industrializing microporous membrane production, are effective in delivering good membranes solely when applied to copolymer (PEDEK-PEEK), and not for homopolymer (PEEK).

Further, while possessing essentially similar fluxes, and similar porosities and pores distribution, microporous membranes of the invention made from copolymer (PEDEK-PEEK) are endowed with significantly improved mechanical properties, as demonstrated notably by their tensile modulus, which significantly exceeds tensile modulus of corresponding membranes made from homopolymer (PEEK) (see Ex. 1(d) A&B with respect to Ex. 2C(d) A). This is particularly unexpected, as base polymers are rather known to display reverse trend. Table 5 below summarizes mechanical properties, as determined on injection molding specimens, made from same copolymer (PEDEK-PEEK) and same homopolymer (PEEK), as used for manufacturing microporous membranes:

TABLE 5
Mechanical properties of injection molded specimens

| | Copolymer | Homopolymer | |
|---|---|---|---|
| | (PEDEK-PEEK) | (PEEK) | Method |
| Tensile Modulus | 3400 | 3500 | ASTM D638 |
| (MPa) | | | |
| Flexural Modulus | 3600 | 3700 | ASTM D790 |
| (MPa) | | | |

Now, microporous membranes made from copolymer (PEDEK-PEEK) possess, at similar gravimetric porosity (between 65 and 70%) and thicknesses (between 300 and 400 μm), tensile moduli which are nearly twice as much as those shown by corresponding microporous membranes made from homopolymer (PEEK). This is hence totally unexpected, when considering mechanical properties of base constituent materials.

As far as Ex. 2C(d)-B is concerned, this example clearly demonstrates that shorter annealing times are ineffective in delivering good membranes when processing homopolymer (PEEK): in this case, membrane obtained has not detectable pore size, causing very low fluxes; furthermore, the residual amount of leachable component is of significance, as shown by the residual weight determinations. Presence of residual polymer (PEI) is known to be detrimental for the chemical resistance of the microporous membrane, although in the determination of mechanical properties on freshly prepared membrane, this may be seen as slightly improving ductility of the same.

1. A microporous article comprising at least one polyaryl ether ketone copolymer [copolymer (PEDEK-PEEK)] comprising:
recurring units (R_{PEEK}) of formula (I): 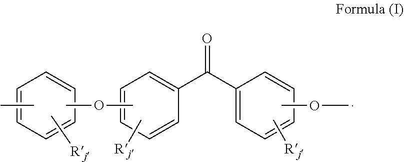
and
recurring units (R_{PEDEK}) of formula (II): 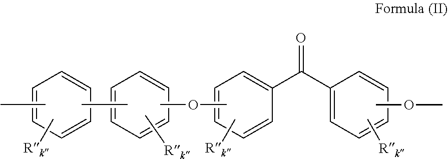
wherein in above formulae (I) and (II), each of R′ and R″, equal to or different from each other, is independently selected at each occurrence from a C₁-C₁₂ group optionally comprising one or more than one heteroatoms; sulfonic acid and sulfonate groups; phosphonic acid and phosphonate groups; amine and quaternary ammonium groups;
each of j′ and k″, equal to or different from each other, is independently selected at each occurrence from 0 and an integer of 1 to 4;
wherein the said recurring units are comprised in a molar ratio (R_{PEDEK}):(R_{PEEK}) of 55:45 to 99:1,
said microporous article having a mean flow pore diameter (MFD), as determined according to ASTM F316-03, of at least 0.005 to at most 0.500 μm.

2. The microporous article of claim 3, said article possessing a gravimetric porosity (εₘ) of 20 to 95% v/v.

3. The microporous article of claim 1, said microporous article having a mean flow pore diameter (MFD), as determined according to ASTM F316-03, of at least 0.008 μm; and/or of at most 0.250 μm.

4. The microporous article according claim 1, said article possessing a water flux permeability, at a pressure of 1 bar and at a temperature of 23° C., of at least 5 l/(h×m²).

5. The microporous article according to claim 1, said article possessing a tensile modulus exceeding 250 MPa when determined at room temperature (23° C.), according to ASTM D638.

6. The microporous article of claim 1, which is a membrane selected from the group consisting of symmetric membranes and asymmetric membranes.

7. The microporous article of claim 6, whereas the membrane is in the form of a flat sheet or in the form of a tubular membrane selected from the group consisting of:
tubular membranes having a diameter greater than 3 mm;
capillary membranes, having a diameter comprised between 0.5 mm and 3 mm; and
hollow fibres having a diameter of less than 0.5 mm.

8. The microporous article according to claim 1, wherein:
the copolymer (PEDEK-PEEK) comprises recurring units (R_{PEDEK}) and (R_{PEEK}) in molar ratio (R_{PEDEK}):(R_{PEEK}) of 60:40 to 95:5; and/or
in copolymer (PEDEK-PEEK), the sum of the amount of recurring units (R_{PEDEK}) and (R_{PEEK}) is of at least 70% moles, with respect to the total number of moles of recurring units; and/or
the copolymer (PEDEK-PEEK) may additionally comprise recurring units (R_{PAEK}) different from recurring units (R_{PEEK}) and (R_{PEDEK}), which are selected from the group consisting of recurring units (R_{PAEK}) complying with any of the following formulae (K-A) to (K-M) herein below: 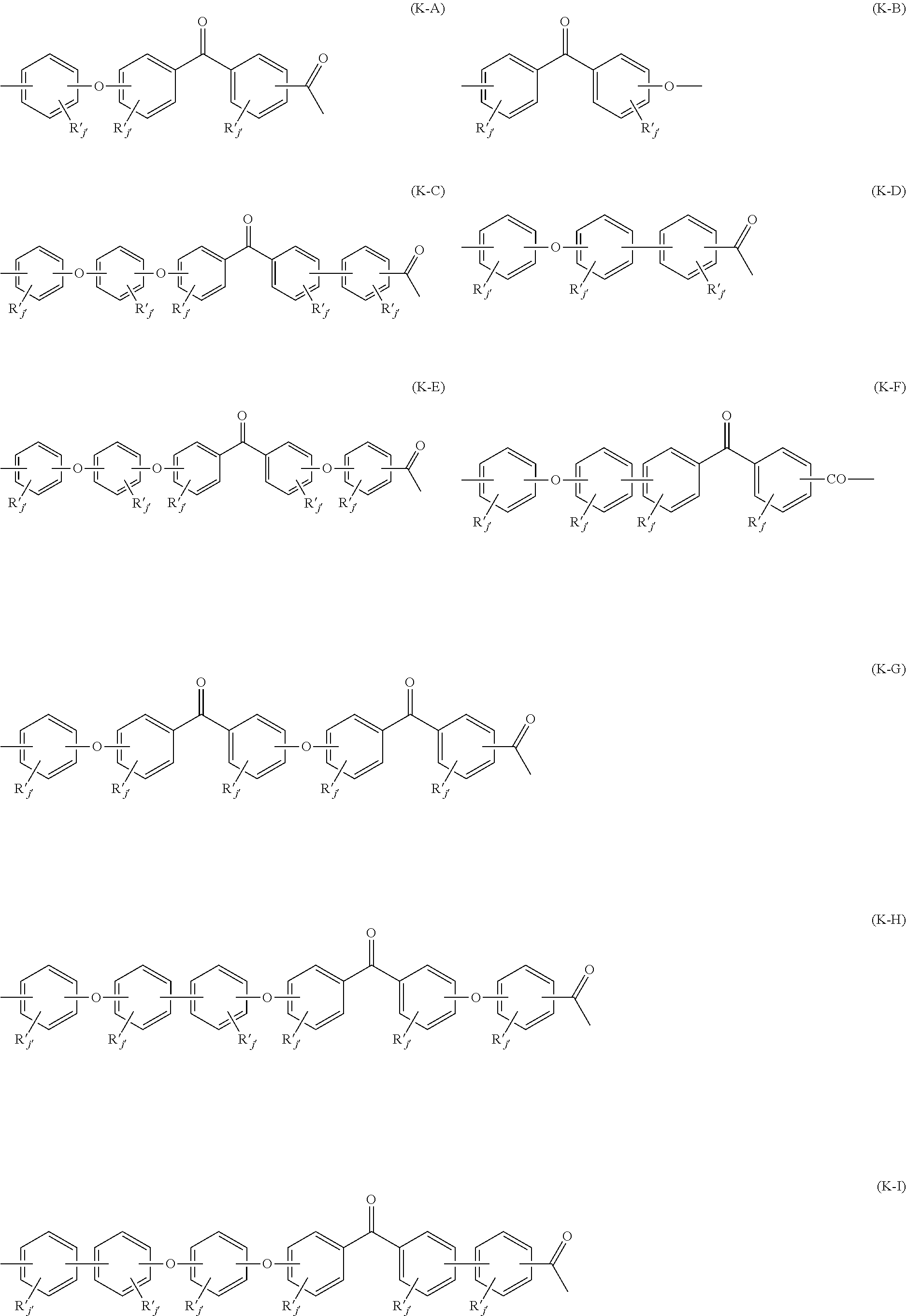 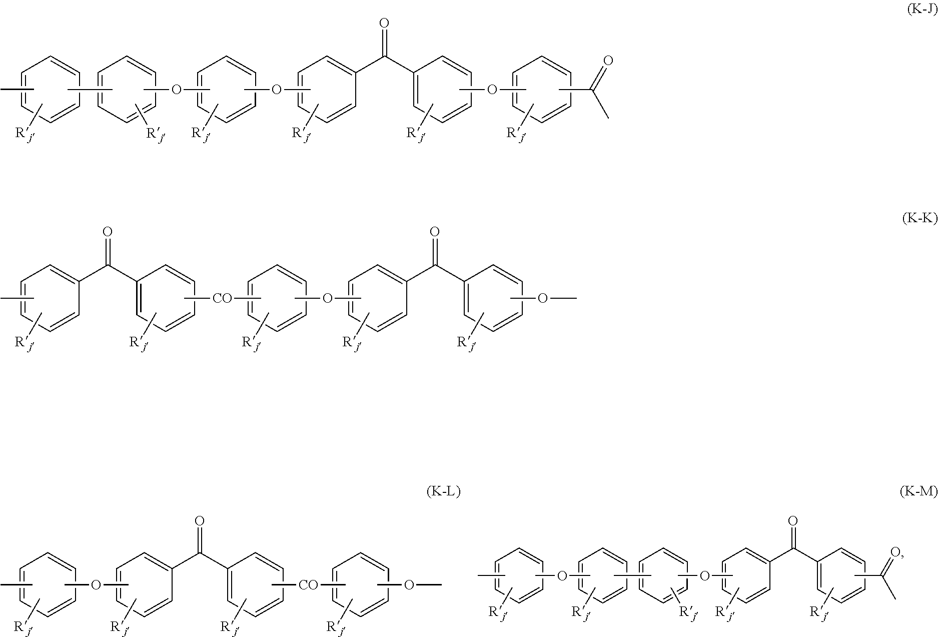
wherein in each of formulae (K-A) to (K-M) above, each of R′, equal to or different from each other, is independently selected at each occurrence from a C₁-C₁₂ group optionally comprising one or more than one heteroatoms; sulfonic acid and sulfonate groups; phosphonic acid and phosphonate groups; amine and quaternary ammonium groups; and
each of j′, equal to or different from each other, is independently selected at each occurrence from 0 and an integer of 1 to 4, preferably j′ being equal to zero.

9. The microporous article according to claim 1, wherein copolymer (PEDEK-PEEK) is comprised essentially of recurring units (R_{PEEK}) and (R_{PEDEK}), and/or wherein in recurring units (R_{PEEK}) of formula (I), the connections among phenyl groups are in the para positions of each of the phenyl rings; and/or wherein each of j′ is zero; and/or wherein recurring units (R_{PEEK}) comply with formula (Ia): 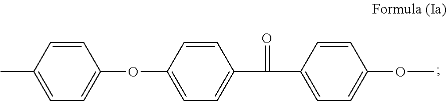
and/or
in recurring units (R_{PEDEK}) of formula (II), the connections among phenyl groups are in the para positions of each of the phenyl rings; and/or each of k″ is zero; and/or wherein recurring units (R_{PEDEK}) comply with formula (IIb):

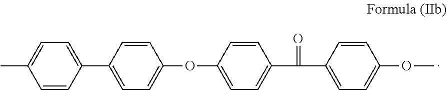

10. A method for making a microporous article according to claim 1, said method comprising:
Step 1.—a step of processing a polymer composition [composition (C)] comprising copolymer (PEDEK-PEEK), and at least one additional polymer [polymer (P)] into a solid article;
Step 2.—a step of thermal treating said solid article, under conditions to cause at least partial crystallization of the copolymer (PEDEK-PEEK), and
Step 3.—a step consisting in removing at least partially said polymer (P) by contacting the thermally treated article obtained from Step 2. with a solvent for said polymer (P), so as to obtain the microporous article of claim 1.

11. The method of claim 10, wherein melt forming is used in Step 1 to process said composition (C) into an article by film extrusion.

12. The method of claim 10, wherein polymer (P) is selected from amorphous polymers, i.e. from polymers having a heat of fusion of less than 5 J/g; and/or wherein polymer (P) is selected from the group consisting of polymers which can form compatible blends with copolymer (PEDEK-PEEK), or polymer (P) is selected from polymers which can form miscible blends, i.e. polymers (P) which, when combined with copolymer (PEDEK-PEEK), provides for blends having a single amorphous phase that exhibits a single glass transition temperature.

13. The method of claim 12, wherein the polymer (P) is a poly(ether imide) polymer [polymer (PEI)] comprising at least 50 mol. %, based on the total number of moles in the polymer, of recurring units (R_{PEI}) comprising at least one aromatic ring, at least one imide group, as such and/or in its amic acid form, and at least one ether group; wherein the recurring units (R_{PEI}) are preferably selected from the group consisting of following formulas (I), (II), (III), (IV), (V) and mixtures thereof: 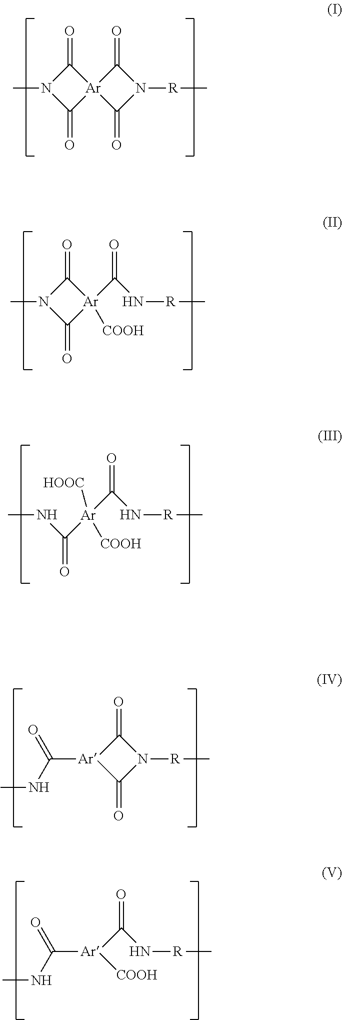
where
Ar is a tetravalent aromatic moiety and is selected from the group consisting of a substituted or unsubstituted, saturated, unsaturated or aromatic monocyclic and polycyclic group having 5 to 50 carbon atoms;
Ar′ is a trivalent aromatic moiety and is selected from the group consisting of a substituted, unsubstituted, saturated, unsaturated, aromatic monocyclic and aromatic polycyclic group having from 5 to 50 C atoms; and
R is selected from the group consisting of substituted and unsubstituted divalent organic radicals selected from the group consisting of
(a) aromatic hydrocarbon radicals having 6 to 20 carbon atoms and halogenated derivatives thereof;
(b) straight or branched chain alkylene radicals having 2 to 20 carbon atoms;
(c) cycloalkylene radicals having 3 to 20 carbon atoms, and
(d) divalent radicals of formula (VI): 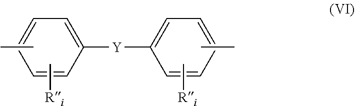
where
Y is selected from the group consisting of alkylenes of 1 to 6 carbon atoms; perfluoroalkylenes of 1 to 6 carbon atoms; cycloalkylenes of 4 to 8 carbon atoms; alkylidenes of 1 to 6 carbon atoms; cycloalkylidenes of 4 to 8 carbon atoms; —O—; —S—; —C(O)—; —SO₂—; —SO—, and
R″ is selected from the group consisting of hydrogen, halogen, alkyl, alkenyl, alkynyl, aryl, ether, thioether, carboxylic acid, ester, amide, imide, alkali earth metal sulfonate, alkaline earth metal sulfonate, alkyl sulfonate, alkali earth metal phosphonate, alkaline earth metal phosphonate, alkyl phosphonate, amine and quaternary ammonium and
i, for each R″, is independently zero or an integer ranging from 1 to 4,
with the proviso that at least one of Ar, Ar′ and R comprise at least one ether group and that the ether group is present in the polymer chain backbone.

14. The method of claim 13, wherein polymer (PEI) is a polymer comprising at least 50 mol. %, based on the total number of moles in the polymer, of recurring units (R_{PEI}) of formula (VII): 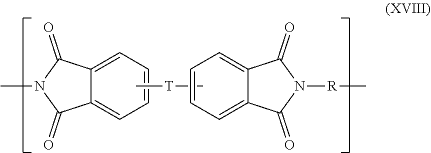
where
R is selected from the group consisting of substituted and unsubstituted divalent organic radicals selected from the group consisting of
(a) aromatic hydrocarbon radicals having 6 to 20 carbon atoms and halogenated derivatives thereof;
(b) straight or branched chain alkylene radicals having 2 to 20 carbon atoms;
(c) cycloalkylene radicals having 3 to 20 carbon atoms, and
(d) divalent radicals of formula (VI): 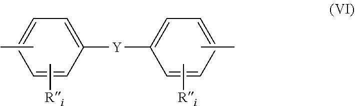
where
Y is selected from the group consisting of alkylenes of 1 to 6 carbon atoms; perfluoroalkylenes of 1 to 6 carbon atoms; cycloalkylenes of 4 to 8 carbon atoms; alkylidenes of 1 to 6 carbon atoms; cycloalkylidenes of 4 to 8 carbon atoms; —O—; —S—; —C(O)—; —SO₂—; —SO—, and
R″ is selected from the group consisting of hydrogen, halogen, alkyl, alkenyl, alkynyl, aryl, ether, thioether, carboxylic acid, ester, amide, imide, alkali earth metal sulfonate, alkaline earth metal sulfonate, alkyl sulfonate, alkali earth metal phosphonate, alkaline earth metal phosphonate, alkyl phosphonate, amine and quaternary ammonium and
i, for each R″, is independently zero or an integer ranging from 1 to 4,
T can either be —O— or —O—Ar″—O—
wherein the divalent bonds of the —O— or the —O— Ar″—O— group can be in the 3,3′, 3,4′, 4,3′, or the 4,4′ positions, wherein Ar″ is an aromatic moiety selected from the group consisting of a substituted or unsubstituted, saturated, unsaturated or aromatic monocyclic and polycyclic group having 5 to 50 carbon atoms; and
wherein Ar″ is preferably of formula (XIX):

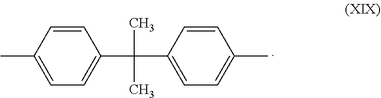

15. The method of claim 13, wherein polymer (PEI) is a polymer comprising at least 50 mol. %, based on the total number of moles in the polymer, of recurring units (R_{PEI}) of formulas (XXIII) or (XXIV), in imide forms, or their corresponding amic acid forms and mixtures thereof:

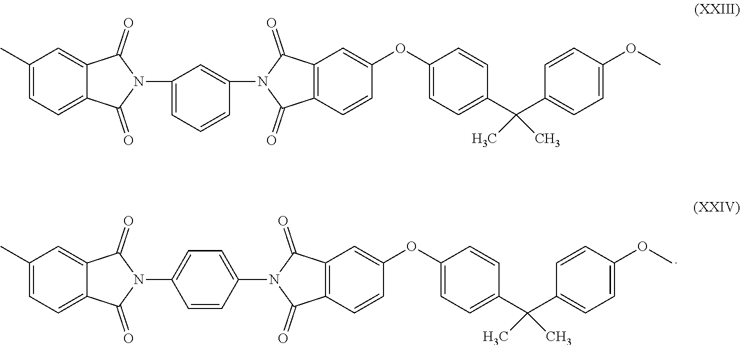

16. The microporous article of claim 1, said article possessing a gravimetric porosity (εₘ) of 40 to 90% v/v.

17. The microporous article of claim 12, said microporous article having a mean flow pore diameter (MFD), as determined according to ASTM F316-03, of at least 0.010 μm; and/or of at most 0.150 μm.

18. The microporous article according to claim 1, said article possessing a water flux permeability, at a pressure of 1 bar and at a temperature of 23° C., of at least 10 l/(h×m²).

19. The microporous article according to claim 1, said article possessing a tensile modulus exceeding 300 MPa when determined at room temperature (23° C.), according to ASTM D638.

20. The microporous article according to claim 1, wherein:
the copolymer (PEDEK-PEEK) comprises recurring units (R_{PEDEK}) and (R_{PEEK}) in molar ratio (R_{PEDEK}):(R_{PEEK}) of 65:35 to 90:10; and/or
in copolymer (PEDEK-PEEK), the sum of the amount of recurring units (R_{PEDEK}) and (R_{PEEK}) is of at least 80% moles, with respect to the total number of moles of recurring units; and/or
the copolymer (PEDEK-PEEK) may additionally comprise recurring units (R_{PAEK}) different from recurring units (R_{PEEK}) and (R_{PEDEK}), which are selected from the group consisting of recurring units (R_{PAEK}) complying with any of the following formulae (K-A) to (K-M) herein below: 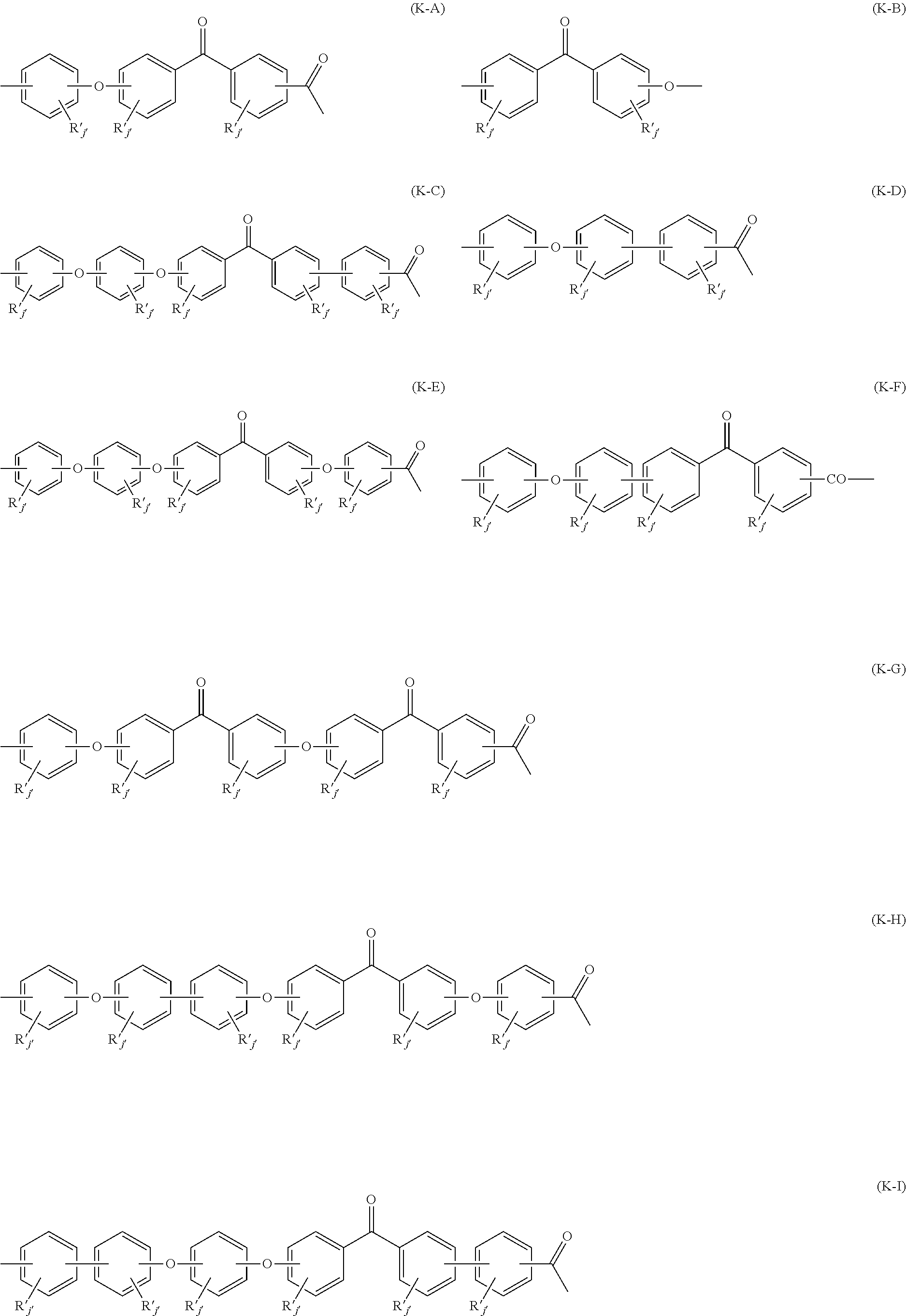 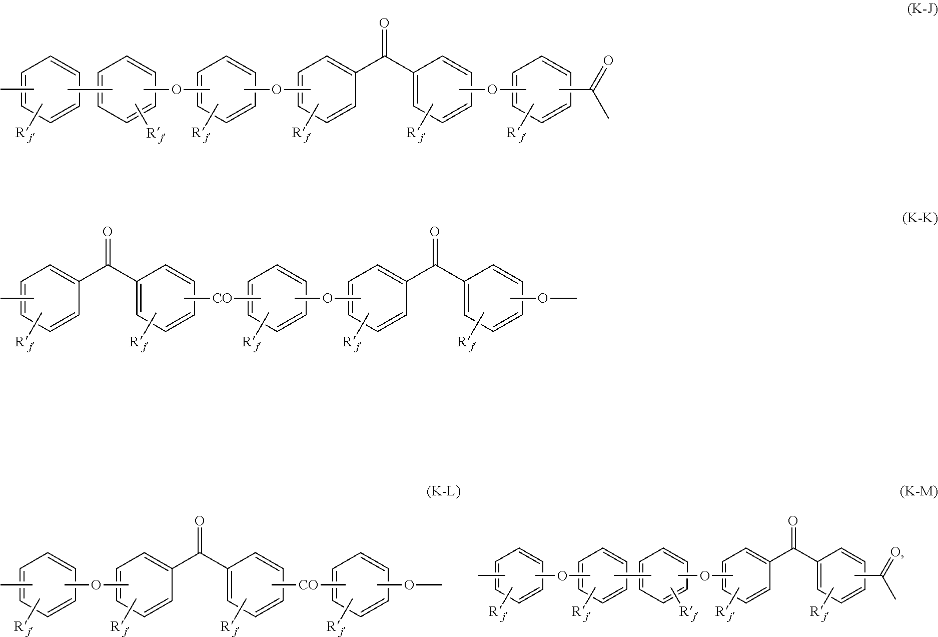
wherein in each of formulae (K-A) to (K-M) above, each of R′, equal to or different from each other, is independently selected at each occurrence from a C₁-C₁₂ group optionally comprising one or more than one heteroatoms; sulfonic acid and sulfonate groups; phosphonic acid and phosphonate groups; amine and quaternary ammonium groups; and
each of j′, equal to or different from each other, is independently selected at each occurrence from 0 and an integer of 1 to 4, preferably j′ being equal to zero.
